(19) United States
(12) Patent Application Publication
(10) Pub. No.: US 2012/0246533 A1
(43) Pub. Date: Sep. 27, 2012

(54) SCALABLE HIERARCHICAL SPARSE REPRESENTATIONS SUPPORTING PREDICTION, FEEDFORWARD BOTTOM-UP ESTIMATION, AND TOP-DOWN INFLUENCE FOR PARALLEL AND ADAPTIVE SIGNAL PROCESSING

(75) Inventor: Zsolt Palotai, Veresegyhaz (HU)

(73) Assignee: SPARSENSE, INC., Boca Raton, FL (US)

(21) Appl. No.: 13/429,256

(22) Filed: Mar. 23, 2012

Related U.S. Application Data
(60) Provisional application No. 61/467,225, filed on Mar. 24, 2011.

(51) Int. Cl. G06F 11/07

(52) U.S. Cl. 714/746; 714/E11.023

(57) ABSTRACT

A method and apparatus for parallel and adaptive signal reconstruction from a multitude of signal measurements. Algorithms and hardware are disclosed to denoise the measured signals, to compress the measured signals, and to reconstruct the signal from fewer measurements than standard state-of-the-art methods require. A parallel hardware design is disclosed in which the methods that are described can be efficiently executed.

### CLAIM OF PRIORITY

This application claims benefit of U.S. Provisional Application No. 61/467,225 entitled “SCALABLE HIERARCHICAL SPARSE REPRESENTATIONS SUPPORTING PREDICTION, FEEDFORWARD BOTTOM-UP ESTIMATION, AND TOP-DOWN INFLUENCE FOR PARALLEL AND ADAPTIVE SIGNAL PROCESSING” by Zsolt Palotai et al., filed Mar. 24, 2011, which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to digital signal processing and more particularly to the reconstruction of signals from a multitude of signal measurements.

### BACKGROUND OF THE INVENTION

Digital signal processing is undertaken or used in many every day life devices, as well as in many special purpose devices, such as medical imaging devices.

In signal processing, both a signal to be measured and the measurement process itself may contain and/or contribute noise. It is advantageous to eliminate noise to obtain better signal processing results, such as sharper images. In some applications the process of signal measurement requires a significant amount of time, such as in medical equipment known as MRI. Therefore, it would be also advantageous to decrease the number of required signal measurements for a given quality of result, as well as achieve the same sharpness and number of pixels with fewer signal measurements.

If a measured signal is to be transferred to some other location, it is also advantageous if the data to be actually sent is as small as possible to lower the required bandwidth, or to increase the rate of sending of complete measurements, such as the frame rate for video signal transmissions.

Sparse representation of signals is a signal processing art in which noise, which can not be represented sparsely, can be filtered out. The sparse representation of a given signal can be estimated from a small number of measurements, where small is compared to the dimension of the signal. Also, a sparse representation generally means that the data is compressed.

There are numerous sparse representation learning algorithms known in the art. These algorithms, however, are not scalable to million dimensional inputs. Also, these algorithms have not been shown to learn the sparse representation that generated the input on artificial data sets; that is, the correctness and convergence of learning is neither demonstrated nor mathematically proven.

There are known hardware designs for operating on large data sets, e.g. large matrix multiplications and neural network simulations. Neural network simulators are known that typically use mixed analog-digital signals, but these make it harder to scale up the hardware. Also, in digital signal operations the bandwidth with which data can be downloaded to the hardware limits the practical size of the hardware.

These are the general areas that embodiments of the invention are intended to address.

### SUMMARY OF THE INVENTION

The invention provides a method and an apparatus for parallel and adaptive signal reconstruction from a multitude of signal measurements.

Reconstruction is achieved by creating a sparse code of the signal from the measurement values, using as few as possible active components in the code, and reconstructing the original signal from this sparse code. The few active components reduce the energy consumption of the reconstruction process. Sparse code allows for the measurement to be smaller dimensional than the signal to be reconstructed. Sparse code also allows for the measurement and the signal to be corrupted by noise. Furthermore, the sparse code reduces the amount of data to be transmitted to other places, saving bandwidth or increasing the rate of sending of individual signal measurements.

The sparse code calculation is based on selection amongst the components of the sparse code. A sparsity measure is used to determine the sparseness of a code. The sparsity measure is based on the number of active components of the code, with the larger the number of the contributing components, the larger the cost and the less preferred the representation. A sparsity constraint is established based on the sparsity measure to determine if a code is sparse enough. Sparsification of the calculated code then occurs, which sparsification can transform the activations of the components in a non-linear manner.

The main features of the calculation of the present invention are the following:
The sparse representation can be divided into clusters;
The sparse representation can be higher dimensional than the signal to be reconstructed;
The cost function to be minimized contains a function of the nonzero values and the weighted reconstruction error;
During phenotype generation (selection of some components as active components) the preferred components can bring in suppressed components and can suppress non-preferred components;
The activation and suppression is based on the learned or prewired similarity, dissimilarity, probability, etc., measurements of the components of the sparse representation;
The continuous values of the active components are calculated by the iteration of some, e.g., stochastic, variant of the derivative of the cost function that decreases the cost function;
The preferences (to be selected as active components during phenotype generation) of the active components of the best sparse codes are increased according to how important a role they have in the reconstruction of the input; and
The phenotype generation stops if a sample reconstructs the input well enough and the sample satisfies the sparsity constraint, or after reaching a maximal iteration number.

The method of the present invention learns appropriate transformations of the signal from the noisy, possibly low dimensional measurements to calculate the sparse code of the signal. These transformations can be prewired if these are known in advance. The method becomes fast, almost feed forward, once the transformations are precise enough. The aim of the adaptation is to improve the reconstruction of the signal with the selected components. The adaptation has nontrivial, necessary additional learning and learning rate tuning These are the following:
The infrequently used components are tuned to become more frequent; and
The learning rate of each component is adaptive and depends on the performance of the component and the similarity and dissimilarity measurements of the components within the same cluster.

The method of the present invention can be implemented efficiently in a parallel, scalable hardware built from low cost, low power components that run the entire algorithm, including the selection based sparse code calculation. The hardware uses design principles made possible by the method. There is no need to use multiple inputs at a time to improve the cost function and the transformations. One input at a time is satisfactory, but the hardware can be multiplied to use the population of individuals. The hardware stores and updates values as locally as possible to decrease the required bandwidth for data transfer. This enables maximally parallel data processing. The hardware can be redundant so that if a few hardware components fail, then the adaptive property of the method makes it possible to not use those failed components.

In one embodiment of the present invention the measurements are magneto-resonance imaging (MRI) measurements of a patient. The signal to be reconstructed is the MRI image. The invention makes it possible to create less noisy, more detailed images, and to transfer or store the images in a compressed form. Also, with fewer measurements the image acquisition time can be reduced without degrading the quality of images, possibly achieving MR video recordings.

In another embodiment of the present invention the signals are video streams for remote robotic surgery. The invention provides means for transmitting the video streams in a compressed form and for reconstructing the video stream on the receiving side even if some part of the compressed signal is corrupted during transmission. This enables higher resolution, and more detailed videos to be transmitted on the same bandwidth as currently used or the transmission of similar resolution video streams on lower bandwidth channels.

### BRIEF DESCRIPTION OF THE DRAWINGS

FIG. 1. is an overview of the architecture of a first method of the present invention;

FIG. 2. illustrates the main steps of the first method;

FIG. 3. is an overview of the sparse code calculation of the present invention;

FIG. 4. is an example of the pseudo code of the sparse code calculation of FIG. 3;

FIG. 5. is an example of the pseudo code of the first method;

FIG. 6. is an overview of the architecture of a second method of the present invention;

FIG. 7. is an overview of custom parallel hardware of the present invention;

FIG. 8 illustrates the decomposition of the input into blocks to reduce hardware area and power consumption;

FIG. 9 illustrates hardware details of the custom parallel hardware of FIG. 7;

FIG. 10 illustrates hardware details of the custom parallel hardware of FIG. 7 when the sparse representation is clustered and the values of Q, W mappings are stored locally at each cluster;

FIG. 11 is a logical system overview showing hardware storage areas of various variables of the pseudo codes;

FIG. 12 is a dataflow diagram showing an example of how a single input signal is processed by hardware components;

FIG. 13 is a system diagram used to describe sparse signal processing in accordance with the present invention for various applications;

FIG. 14 is a system diagram used to explain signal compression and decompression in accordance with the present invention; and

FIG. 15 is a system diagram used to provide component detection and tracking of a signal.

### DETAILED DESCRIPTION OF THE INVENTION

As described above, digital signal processing is undertaken in many of today's electronic devices, where the signal to be measured and the measurement process may contain and/or contribute noise. Thus, it is advantageous to eliminate noise to obtain better signal processing results. Sparse representation of signals is a signal processing art that can be used to filter out noise. Traditional sparse representation algorithms are not scalable to a million dimensional inputs. Further, traditional hardware designs do not provide for a convenient scalable system. However, in accordance with an embodiment of the invention, described herein are systems and methods to provide a method which results in a sparse representation for a measured signal that scales for million dimensional inputs, and an apparatus that can realize this method.

### I. One Method of the Present Invention

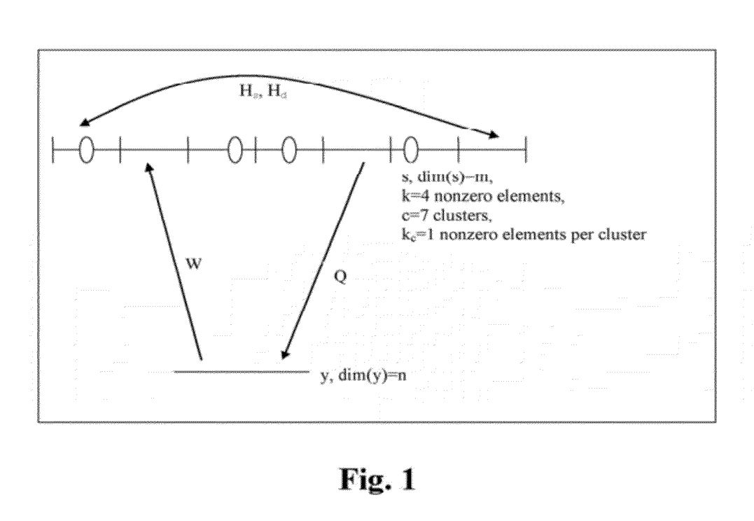

With reference to FIG. 1 which illustrates the architecture and notations of this method, in this embodiment, a signal is measured by an identity transformation. To reconstruct the measured signal, it is sufficient to reconstruct the measurement by the transformations. Particularly, denote the signal measurement as y, the sparse representation as s, the mapping that transforms from s to y by Q, and the mapping that transforms from y to s by W; these are the transformations to be learned or prewired. Denote the dimension of y by n, the dimension of s by m, and the number of maximum nonzero elements in s by k. The following constraints hold: k<<n<m.

Further constraints on the sparse representation may be introduced. The sparse representation possibly may be partitioned into clusters. Thus, denote the number of clusters by c. Furthermore, the maximal number of nonzero elements in a cluster can be k_{c}, c*k_{c}>=k. It is possible to choose c=1 and k_{c}=k; that is there is only one cluster and that contains all of the components. The functions Hₛ(i,j) and H_{d}(i,j) estimate the similarity and dissimilarity measures between the components of s. Furthermore, denote the mapping from the i^{th} component of s to y by Q_{.,i} and the mapping to the i^{th} component of s from y by Wᵢ.

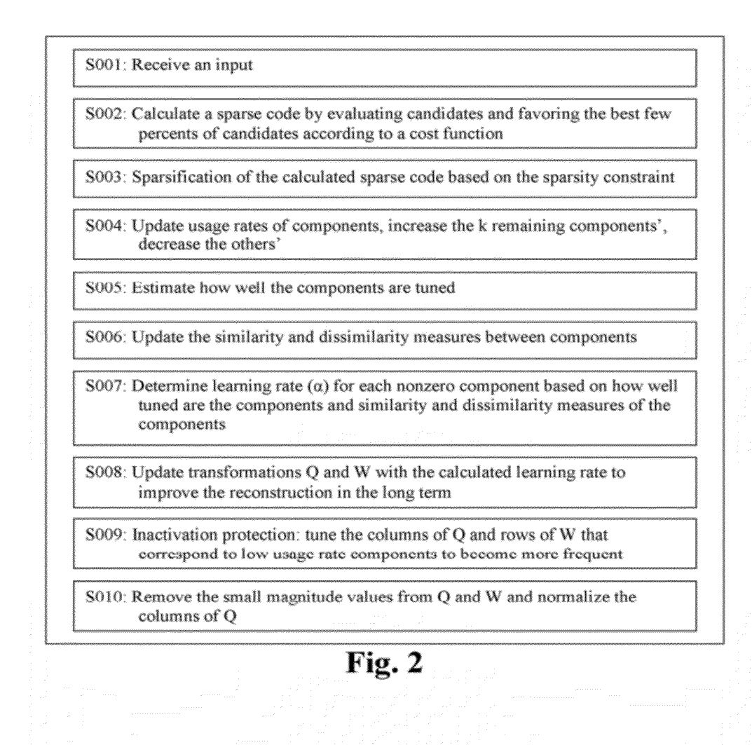

FIG. 2 shows the main steps of the method of FIG. 1, which are as follows: First, an input is received (S001). Then, a sparse code is calculated for the input with the actual Q, W transformations and H functions (S002). Once a sparse code is calculated this code is sparsified based on the sparsity constraint (S003), e.g., it is truncated to the k largest magnitude components, the smaller magnitude components are set to 0, and some of the components of the k largest components may be set to 0 if their values are small. Hereafter, the value “small” means a constant times the actual maximum value, where the constant is, e.g., 0.001. The usage rates of the components are stored (S004) to tune the infrequently used components to become more frequent (S009). To keep the well tuned components, it is estimated how well each component is tuned (S005). Then, similarity and dissimilarity measures between components are maintained (S006). After these measures are updated, the learning rate of components for tuning mappings Q and W are determined (S007). A component's learning rate depends on how well tuned is that component and on the similarity and dissimilarity measure of the components within the same cluster. If a component does not belong to that cluster based on its measures, then its learning rate can be larger. Once the learning rate of each component is determined, transformations Q and W are updated to improve the reconstruction error in the long term (S008). After this, the inactivation protection tunes the infrequently used components to become more frequent (S009). Finally, the small magnitude values are deleted from Q and W and the columns of Q are normalized (S010).

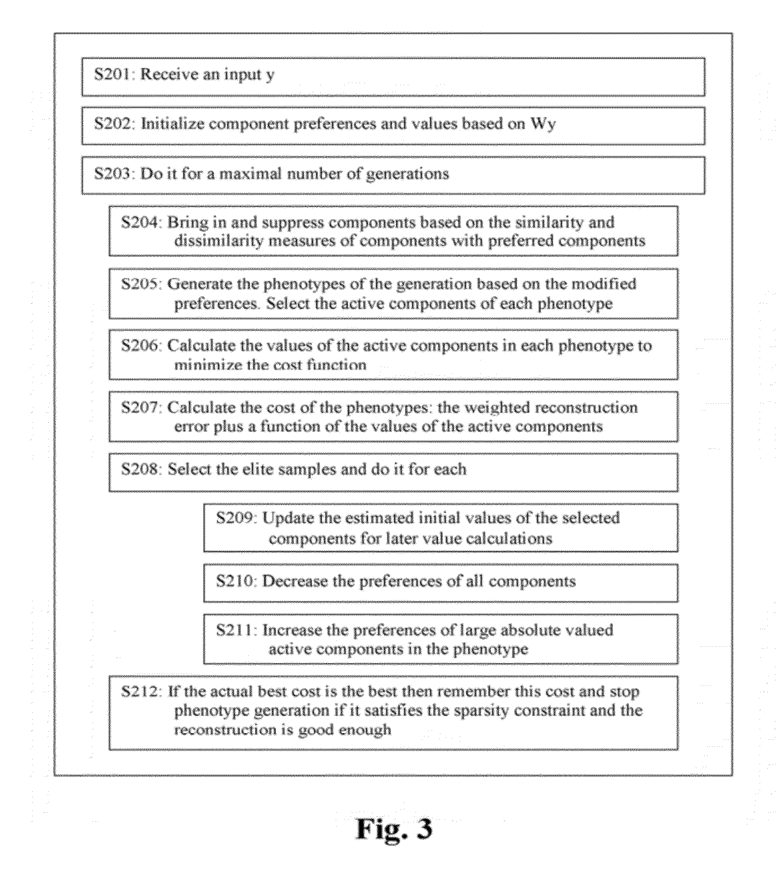

FIG. 3 illustrates in more detail the step (S002) of FIG. 2 in which, as described above, the sparse code s of a given input y is determined by a selection based method (SM) (S002). FIG. 3 shows the main steps of SM. SM tunes the preference of selecting a component of s as an active component based on a cost function (S207). If the actually selected components (phenotype) have a cost function value that belongs to the elite (e.g., the best p percent of cost function values) (S208) then the preferences of those components that have an important role in the reconstruction of the input signal are increased (S211) and the preferences of the other components are decreased (S210). An online SM can estimate the elite set, e.g., by maintaining an elite threshold. If the actual value of the cost function is below the threshold then the actual phenotype is elite, otherwise it is not. The phenotype generation is based on the preferences of the components. The more preferred a component is the more probable that it will be active in a phenotype (S205). Before a phenotype is generated, the preferred components can activate or suppress other components (S204). The activation or suppression is based on the similarity and dissimilarity measures between components. After the active components of a phenotype are selected, the continuous values of the active components of a phenotype are calculated to minimize the cost function (S206). Some calculations enable to initialize the continuous values of the active components. The initial values of components are estimated from the continuous values of the elite phenotypes (S209).

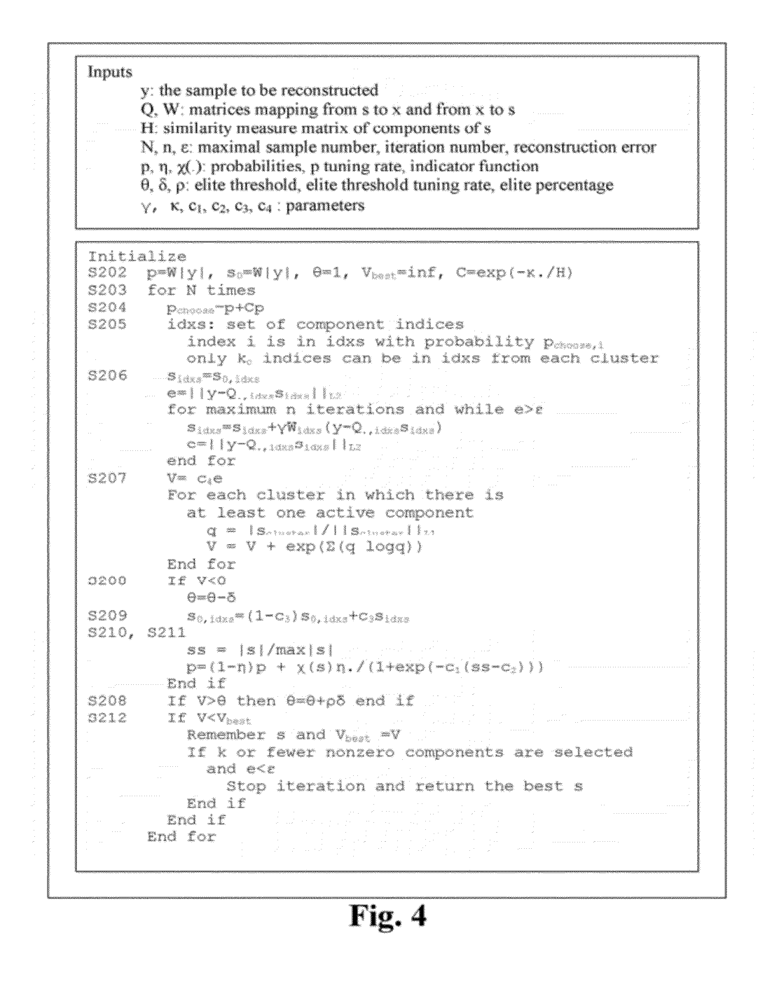

In one particular embodiment of the selection based method SM, a modified online cross-entropy method (CEM) is used. FIG. 4 illustrates an exemplary pseudo code of the sparse code calculation. The modified online CEM works in the following manner. Denote the probabilities of activation of the components of s by p. Denote by C a suitable transformation of Hₛ that emphasizes the large values, e.g., C_{i,j}=exp(−κ/Hₛ(i,j)), where κ is a positive real number. Denote by θ the actual elite threshold and by δ the elite threshold update size. In each generation only one phenotype is generated and an elite threshold is maintained to decide whether the actual phenotype is elite. The active components of a phenotype are independently chosen according to their modified probabilities (S205). The activation and suppression is based on H (S204).

An example embodiment is the following: the elements are chosen according to probabilities p_{choose}=p+Cp, where C=exp(−κ./Hₛ), and κ=1. Other examples include but are not limiting when pᵢ is updated by Π_{D}ΣⱼCᵢⱼpⱼ, or Σ_{D}ΠⱼCᵢⱼpⱼ, or Π_{D}ΠⱼCᵢⱼpⱼ, where D goes through the sets of indices of components of a cluster and j goes through the indices in a D, and any other function of similarity and dissimilarity measures and p, e.g., exp(Cp). Then the continuous values of the selected components in s are calculated (S206). These are determined to minimize, e.g., the L2 norm of the reconstruction error: ∥y−Qs∥_{L2}.

There can be several embodiments for the calculation: calculate the pseudo inverse of the Q submatrix corresponding to the selected components; solve the linear system only with the selected components, that is, the system is over-determined and can be solved; iteratively determine the values of the selected components by the iteration of some, e.g., a stochastic, variant of the derivative of the cost function that decreases the cost function, e.g., s(t+1)=s(t)+γ(t)Wf(y−Qs(t)), γ=0.01 and f(.) is a possible nonlinearity, for the selected components, stopping the iteration if the error is below a threshold or after reaching an iteration limit number. The latter embodiment allows for a scalable parallel hardware design described herein below. That embodiment also allows initializing the component values by their estimated values.

The estimated values of the components are initialized with Wy in the beginning of phenotype generation and are tuned towards the actually computed values, for example with moving window averaging, after each elite phenotype (S209), where the update rate c₃ is, e.g., 0.01. The estimated values can be updated by temporally modifying the W transform to transform the current input y to the values of the elite samples, e.g.: W(t+1)=W(t)+α(s−W(t)y)y^{T} if s is elite. Another possibility is to use a transform B that calculates the estimated values of active components from Wy, e.g.: BWy gives the initial values of the active components, and B is updated ifs is elite: B(t+1)=B(t)+α(s−B(t)Wy)(Wy)^{T}. Next, the cost function is calculated for the actual phenotype, which can be the number of active components in the phenotype plus the weighted reconstruction error (S207). The weight is determined so that the reconstruction error is more important than the first part. If the calculated value is below the actual elite threshold then this phenotype is an elite (S208), otherwise the elite threshold is increased with ρδ, ρ=0.05, δ=1e−3. If the phenotype is elite, then the elite threshold is decreased with δ and some components' preferences are increased (S211) and all others' preferences are decreased (S210).

A component's preference is increased if it is selected and if its magnitude is in the same order as the largest magnitude of components (S211). An example embodiment of this is the following: ss=|s|/max|s|, p+(1−η)p+χ(s)η./(1+exp(−c₁*(ss−c₂))), c1=100, c2=−0.2, η=0.01 and χ(.) is the indicator function which is 0 where the input is 0, otherwise it is 1. The phenotype generation stops if a given maximum number of phenotypes are reached or if the reconstruction error is below a threshold with at most k selected components (S212). The code with the best cost is remembered and returned as the result.

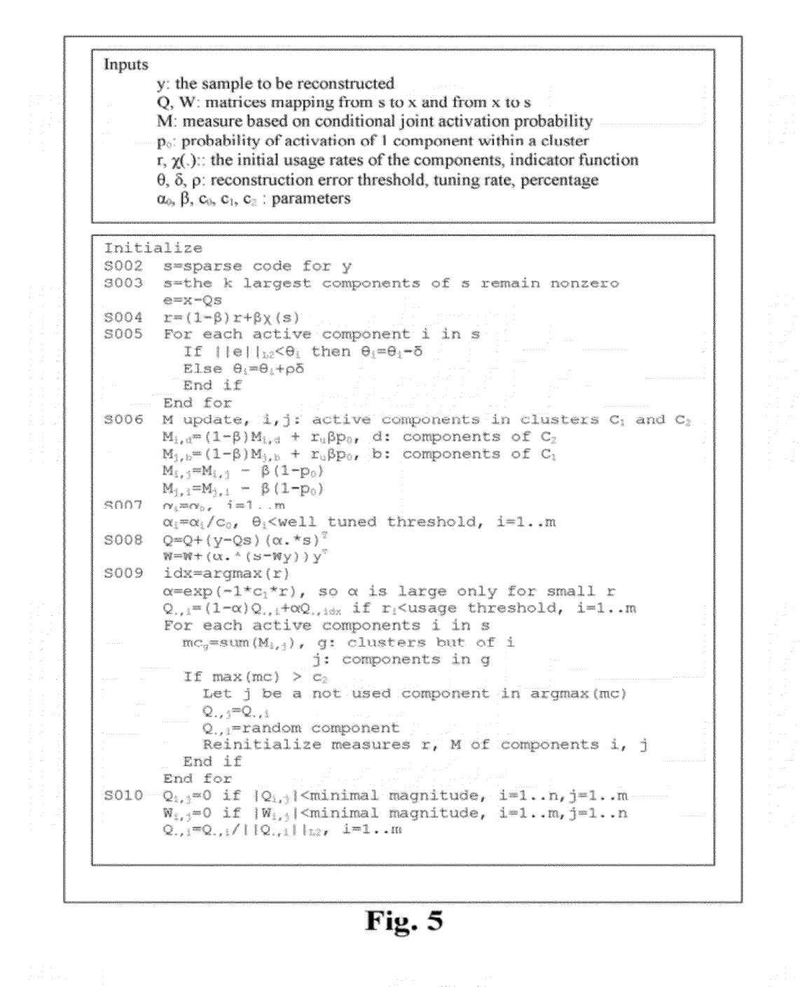

Once the sparse code is calculated, as shown in FIG. 4, it is sparsified based on the sparsity constraint, e.g. it is truncated to the k largest magnitude components (S003) (FIG. 5). The smaller values are set to 0. This step is required during adaptation when there are not well tuned components. In this case the calculated sparse code is not enough sparse, so the code must be made sparse directly.

There are several measures of the components that should be maintained.

The usage rate of a component is the ratio of inputs in which the component is active. Once the truncated sparse code is obtained the usage rate of the components can be updated (S004) (FIG. 5). The active components' rates are increased and the inactive components' rates are decreased. An example implementation is the following: r(t+1)=(1−β)r(t)+βχ(s), where β is chosen so that each element in s has a chance to be selected enough times to get an approximately good estimation of usage rates, e.g. β=k/(100 m), and χ(.) is the indicator function which is 0 where the argument is 0 and it is 1 otherwise.

It can be estimated in many different ways how well each component is tuned (S005) (FIG. 5). An example is based on the elite cost function threshold. A component is well tuned if it can reconstruct some inputs so that the reconstruction error is low enough. The elite reconstruction error threshold of a component is updated so that a small percent of reconstruction errors (e.g. 5 percent) when the component is active will be under this threshold. That is, if this threshold is small enough then that component can reconstruct some inputs well enough; therefore the component is well tuned. For each active component in the actual sample if the reconstruction error is below the component's threshold then its threshold is decreased, otherwise it is increased with, e.g., the 5 percent of the amount of decrease.

Another example uses a friend list of components for each component. The friend list of a component has a fixed length and contains the indices of other components as list elements. The list is ordered according to the values of the list elements. The values of the list elements are updated in the following way. When another component is active in a sparse code with the actual component being investigated, then the other component's value in the list is moved towards the reconstruction error of the sparse code. The list contains the smallest valued indices. A component is well tuned if its friend list contains enough number (e.g. k) of indices with enough low values (e.g. 0.001∥y∥_{L2}).

Similarity measures can be, e.g., Euclidean distance, its exponentiated form, mutual information between the components, or a suitable approximation to it, or any temporal variant, e.g., time-delayed second order mutual information (S006) (FIG. 5). An example similarity measure is the magnitude of the pair-wise mutual information. This measure can be used both to determine the learning rate of components and to modify the preferences of components for sample generation. The magnitudes of the pair-wise mutual information (PMI) of a component with the other components are estimated differently with components in the same cluster and with components in different clusters. The PMI magnitude estimations of a component with each component in the same cluster are calculated and maintained. But PMI magnitude estimations of a component with components in different clusters are truncated so that only a given number (e.g. 0.01 m) of the largest values are maintained to reduce memory requirements. PMI magnitude can be estimated, e.g., by summing up some nonlinear correlations of the components. Another similarity or dissimilarity measure is the pair-wise conditional probability of activation of components. The condition can be if one component is active, or if one component is active and the other component is selected from a given cluster. To store efficiently this measure it should be transformed into a sparse measure. An example transformation is the following.

The measure should be large when 2 components do not fire together (i.e. they probably belong to the same cluster) and small when 2 components fire together with the average expected rate. Also, this measure should be calculated only among components from different clusters. The learning of the similarity and dissimilarity measures can be speeded up by low-dimensional embedding methods.

After this the learning rate of each component can be determined (S007) (FIG. 5). The learning rate of the i^{th} component determines the change rate of the i^{th} column of Q and the i^{th} row of W. The learning rate of a component is small if it is well tuned. The learning rate of a component is large if its average mutual information estimation within its cluster is smaller than the average mutual information of the components within its cluster.

After these measures are updated the matrices Q and W are tuned to decrease the reconstruction error, e.g., by gradient descent learning (S008) (FIG. 5): Q(t+1)=Q(t)+(y−Q(t)s)(α.*s)^{T}, and W(t+1)=W(t)+(α.*(s−W(t)y))y^{T}, or any stochastic variant of it. Another example for this tuning is to use a discretization learning algorithm, e.g., soft or hard winner take all algorithms, independent component analysis. After this the low usage rate components are tuned towards the elements with the highest usage rates (S009) (FIG. 5). With this tuning more components will be responsible for the reconstruction of frequently occurring input patterns, adaptively increasing the resolution of these patterns.

Another example for tuning is neighbor teaching based on the similarity and dissimilarity measures. The neighbors of an active component are tuned towards the active component (Q_{.,j}=(1−cnᵢⱼ)Q_{.,j}+cnᵢⱼQ_{.,i}, where i is an active component, and j is a neighbor of i by the measure nᵢⱼ, and c is a tuning rate parameter). A component is the neighbor of another component if they are similar according to the similarity and dissimilarity measures, e.g., their similarity measure is above a threshold. Here occurs the reordering of components among clusters. If there is a component which is not active with most of the components from another cluster then that component should be moved to the other cluster into the place of a not used component. The original place of the component can be randomly reinitialized and the measures of the new and original place of the component are reset to a default value.

Another example for tuning is to use the elite concept of CEM. The above introduced update rules are applied only if the current sparse representation and the current input are elite, that is the current sparse representation reconstructs the input well enough. In another way of using CEM an average value and a standard deviation is maintained for each matrix element. The current values of matrices Q and W for the current input are sampled from normal distributions with the maintained averages and standard deviations. Then the averages and standard deviations can be tuned according to the online CE method. If the current matrix values resulted in a sparse representation that reconstructs the input well enough then the average values are moved towards the current values of matrices Q and W and standard deviations are updated according to the standard deviations of the elite values.

Finally, the small magnitude values from Q and W matrices are removed so that each column of Q and row of W contain maximum a fixed number of nonzero elements and the columns of Q are normalized to prevent arbitrary large values within Q (S010), e.g., Q_{.,i}=Q_{.,i}/∥Q_{.,i}∥_{L2}, i=1 . . . m.

### II. Another Method of the Present Invention

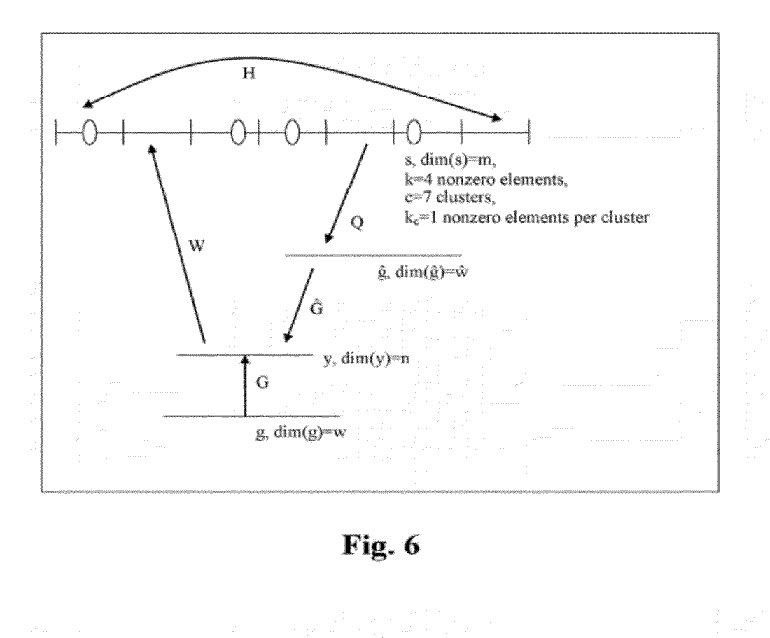

FIG. 6 shows the overview of the architecture of this method. In this method signal g is measured by transformation G, so that the measured quantity is then y=G(g). Denote the dimension of the signal by w, w>=n that is the signal is potentially larger dimensional than the measurement.

The only difference in this case from the method of FIG. 1 is that Q maps from s to ĝ, and the estimated measurement is calculated as ŷ=Ĝ(ĝ)=Ĝ(Qs). The estimated signal dimension can be larger than the original signal dimension to achieve super-resolution, e.g., if G is a measurement matrix, Ĝ maps from larger signals than G does, and Ĝ contains interpolated values of G.

A hierarchical organization can be constructed from both of the methods. In a hierarchical organization the input of a next level is provided by a possibly nonlinear transformation of the sparse representations and reconstructed inputs of the previous levels. The input to the very first level is the input signal to be processed. The output of the system is the sparse representation and the reconstructed input at each level.

### III. Summary of Method I and Method II

The above-described methods provide for parallel adaptive signal reconstruction from a multitude of measurements of a signal. These methods use a first sparse code which is generated from the received input signal. The first sparse code is nonlinearly sparsified to meet a sparsity constraint. Then the input signal is reconstructed from the sparse code producing a processed signal. The sparsity constraint is defined with the help of a sparsity measure that defines how sparse the sparse code is. The sparsity measure itself is based on a number of active components in the sparse code.

To generate the sparse representation and to reconstruct the input two transforms W and Q are used. A cost function is defined to measure the quality of the sparse representation, which cost function is based on a sparsity measure and a correlation quality of the reconstruction of the input signal. During calculation of the first sparse code some similarity and dissimilarity measures of the components of the sparse code are used. The W and Q transforms and the similarity and dissimilarity measures can be pre-wired or can be learned by the methods.

An individual learning rate is determined for each nonzero component of the sparse code. The learning rate of a component can depend on its usage rate and the similarity and dissimilarity measures with other components. The tuning of the transforms W and Q are to decrease the value of the cost function. Also there are tunings of transforms W and Q that make the low usage rate components of the sparse code more frequent. And, the values that are smaller than a threshold are removed from transforms W and Q and Q is normalized.

Furthermore, the selection based method described above is used to generate a first sparse code for an input signal with given transforms W and Q and similarity and dissimilarity measures of components in the following way. An initial preference of each component of the sparse code to become active is determined. Iteration begins. In one round of the iteration a population of phenotypes containing at least one phenotype is generated based on modified preferences. The modified preferences are calculated from the preferences of the components based on the similarity and dissimilarity measures. A phenotype is generated by selecting some active components based on their modified preferences and by calculating the continuous values of the active components to decrease the cost function. The cost function is evaluated for each phenotype and an elite set of phenotypes is determined containing the best few percent of phenotypes. The preferences of components of the sparse code are tuned based on the elite phenotypes. The iteration stops if the best value of the cost function is below a threshold and the corresponding phenotype satisfies the sparsity constraint or after reaching a maximal repetition number.

A hierarchical organization can be built from a multitude of the above methods. The input of a method in the hierarchy is a nonlinear function of the reconstructed inputs and sparse codes of the methods below the actual method in the hierarchy.

The initial preferences of the components of sparse code can be initialized from the received input by transform W.

Time dependent signals can be processed with the methods. One approach is to ignore time dependence. Another approach is to use concatenated input of single time signals. If the current signal and the previous t−1 signals are concatenated then the input of the method is t times larger than a single time signal. Yet another approach is to use concatenated input of different convolutions of single time signals. In this case if d different convolutions are used then the input of the method is d times larger than a single time signal. A convolution can contain arbitrary long time window of single time signals without increasing the size of the method input.

If time dependent input is processed then similarity and dissimilarity measures can include time dependency measures, or the parameters of predictive models on the sparse code. The models can be for example autoregressive integrating moving average models that can predict the preferences of the components of the sparse code of the current input from the previously calculated sparse codes of previous inputs.

The calculation of the modified preferences can be done e.g. by applying a diffusion model on the preferences with parameters depending on the similarity and dissimilarity measures of the components of the sparse code. This diffusion can be extended to time domain by predictive models. That is, the modified preferences can also depend on the previously calculated sparse codes of previous inputs.

The steps of the methods described in Section I, II and III, and as claimed herein, may be performed in different order while achieving the same or similar results. The present method invention is not limited to any one specific order of steps.

### IV. Hardware of the Present Invention

### A. Generally

In one embodiment, either method described above in Section I and Section II may be executed by a general purpose computer (GPC), or several GPCs, or a cluster of GPCs, or a grid of GPCs. The GPC may include graphics card processors, game console hardware (PS3, etc.), cell processors, personal computers, Apple computers, etc.

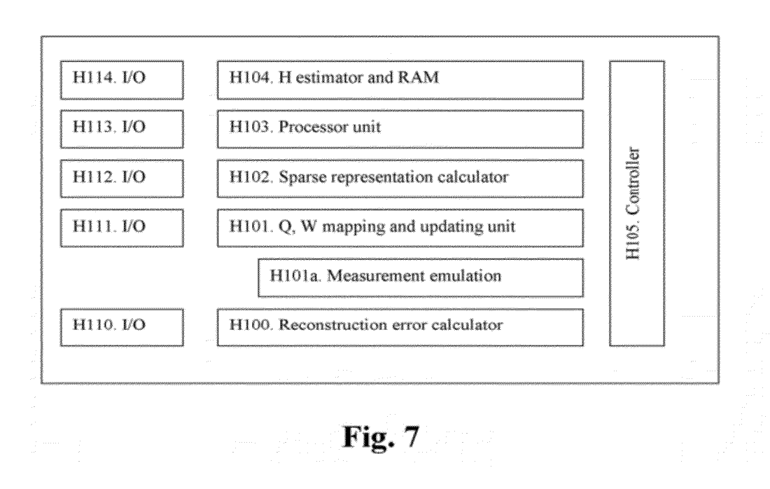

In another embodiment, either method may be executed in special parallel hardware described below. FIG. 7 shows an overview of the components of the custom parallel hardware. There is a Processor unit with enough local RAM for the selection based algorithm to calculate sparse code, and the calculation of α (H103). There is a hardware unit with RAM for estimating and storing the inter-component similarity and dissimilarity measures (H104). There is a hardware unit to store and update the sparse representation during calculation (H102). There is a hardware unit to store matrices Q and W and to compute the mappings of Q and W and the update of Q and W with a given α (H101). For the method described in Section II above, there is a hardware unit that emulates the measurement, e.g. multiplies ĝ by Ĝ and stores Ĝ (H101a). This unit can be omitted entirely if the measurement transformation is the identity transformation. There also is a reconstruction error calculation unit which calculates the reconstruction error (H100). These units are all made of simple components and are easily scalable for large dimensions. There are I/O channels for each hardware unit (H110-H114) and there is a controller unit that controls the units to execute a given function (H105).

The precision of the hardware units can be fitted to the actual signal processing problem, e.g., 32 bit floating point or 64 (8.56) bit fixed point.

Adders and multipliers work in the following way. If their output is 0, then they should not consume considerable power. If one of their inputs is 0 then they should not consume considerable power for calculation. This ensures low power consumption with sparse code calculations.

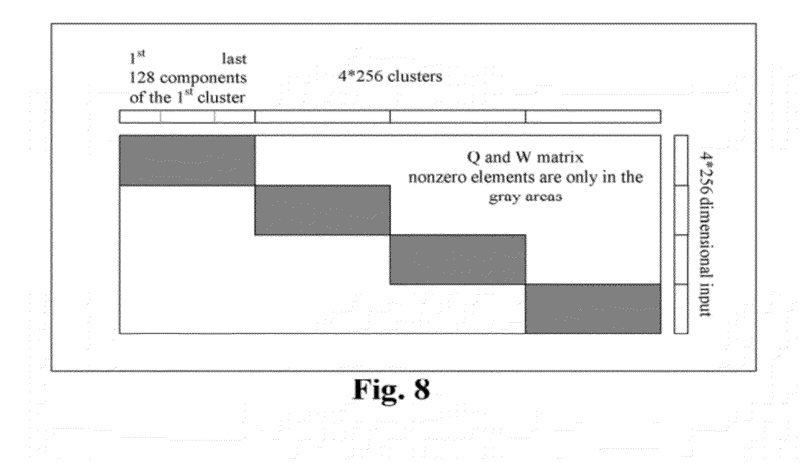

The input and sparse representation can be divided into blocks in order to reduce required hardware area and power consumption. For example, the input is 1024 dimensional and the sparse representation contains 1024 clusters with 128 components in each cluster (see FIG. 8). The input can be divided into 4 times 256 dimensional parts and the sparse representation can also be divided into 4 times 256 clusters. If the first 256 dimensions of the input can only be reconstructed by the first 256 clusters, then the 256*256 sized 4 blocks of input and clusters become independent from each other and only the inter-component similarity and dissimilarity measures connect them. This is enough to remove the artifacts of block arrangement from the reconstruction.

### B. Hardware Components

### 1. Reconstruction Error Calculator Unit (H100)

This unit calculates the reconstruction error, and stores the reference input, and the reconstructed input.

The following interfaces are provided:
1. Reference input setting and querying;
2. Reconstruction error querying;
3. Reconstruction error size querying (in a predefined norm, e.g., L2);
4. Reconstructed input setting and querying; and
5. Working mode setting and querying (0: idle, 1: calculate reconstruction error and error size).

The following operations are provided:
1. The received reference input is stored until a new reference input is received;
2. The received reconstructed input is stored until a new reconstructed input is received; typically, more reconstructed input is received for a single reference input;
3. When a new reconstructed input is received and the working mode is set to 1, the reconstruction error is calculated as fast as possible (preferably during one clock cycle) and stored until a reconstructed input is received; and
4. When a new reconstruction error is calculated then the new reconstruction error size is updated, preferably during log n clock cycles, where n is the size of the input; after the calculation is finished working, the working mode is set to 0.

The following connections are provided:
1. The reference input is received from the host device;
2. The reconstructed input is received from unit (H101) and queried by the host device through the main I/O;
3. The reconstruction error and reference input are used by unit (H101) and can be queried through the main I/O;
4. The reconstruction error size is used by unit (H103) and can be queried through the main I/O; and
5. The working mode is queried and set by the Controller (H105).

One implementation is the following. The data is stored in 4*n+1 registers, in which 3*n registers are used for the reference input, reconstructed input and reconstruction error. Each register of the reconstruction error is connected to the output of an adder, that calculates the difference between the reference input and the reconstructed input, e(i)=x(i)−y(i), where x is the reference input, y is the reconstructed input, e is the reconstruction error, and z(i) denotes the i^{th} component of the vector. The reconstruction error size is stored in the plus 1 register. To calculate L2 norm a multiplier is used for each component of the reconstruction error that calculates the square of that component and writes the result to n registers. Then, an adder tree adds up the squares of the registers. The total number of required adders is 2*n (error calculation and error size summation). The total number of required multipliers is n (square calculation). Plus, one register for the working mode and control logic are used to control the working of this block.

### 2. Sparse Code Calculator Unit (H102)

The sparse code calculator (H102) stores an actual sparse code and updates it depending on the working mode. During sparse code calculation, the received update vector multiplied by update rate is added to the actual sparse code and the new vector replaces the actual sparse code. During W tuning the sparse code error is calculated; that is, the received initial guess of the sparse code is subtracted from the calculated sparse code and the error vector is stored for further calculations.

The following interfaces are provided:
1. working mode setting and querying (0: idle, 1: sparse code calculation, 2: W tuning);
2. actual sparse code setting and querying;
3. update vector or initial guess setting; and
4. update size setting and querying.

The following operations are provided:
1. common:
   a. The actual sparse code is stored until an update is received or a new actual sparse code is received; and
   b. The working mode is set to 0 after an operation is finished.
2. working mode 1 (sparse code calculation):
   a. When an update vector is received and working mode is set to 1, the update vector is multiplied by the update size and added to the actual sparse code; the resulting vector replaces the actual sparse code.
3. working mode 2 (W tuning):
   a. When an initial guess sparse code vector is received and the working mode is set to 2 the guess is subtracted from the stored actual sparse code and both the result and the actual sparse code are stored.

The following connections are provided:
1. The update size is set and queried by the Processor unit (H103) and through the main I/O;
2. The actual sparse code is set and queried by the Processor (H103) and (H101) units and through the main I/O;
3. The update size and initial guess of sparse code are received from unit (H101);
4. The sparse code error is used by unit (H101); and
5. The working mode is set and queried by the Controller (H105).

One implementation is the following. The data is stored in 3*m+1 registers. The actual sparse code is stored in m registers. The update rate is stored in the plus 1 register. In working mode 1 the received update vector is stored in m registers and a multiply-and-adder for each component adds the update vector multiplied by the update rate to the stored sparse code and writes the result to a third set of m registers; after this the result is copied to the first set of m registers to store the updated sparse code. When actual sparse code is queried the values of the first set of m registers are returned. In working mode 2 the received initial guess is stored in the second set of m registers and the multiply-and-adders for each component now subtracts this initial guess from the actual sparse code and writes the result to the third set of m registers. When the sparse code error is queried then the stored values of the third m registers are returned. Plus, one register for the working mode and control logic are used to control the working of this unit.

### 3. Q, W Mapping and Updating Unit for Matrices (H101)

This unit (H101) multiplies the sparse code with Q, multiplies the reconstruction error with W providing a sparse code update, updates Q with the multiplication of the reconstruction error and the sparse code, and updates W with the multiplication of the sparse code error and the reference input.

The following interfaces are provided:
1. working mode setting and querying (0: idle, 1: sparse code update calculation, 2: Q update, 3: W update);
2. setting and querying of learning rates of components for Q and W tuning separately;
3. setting and querying of small value threshold; and
4. setting and querying of Q and W matrices.

The following operations are provided:
1. common:
   a. matrices are stored; and
   b. working mode is set to 0 after an operation is finished.
2. working mode 1:
   a. load matrix values to multipliers;
   b. calculate reconstructed input from actual sparse code (with 100 MHz at least); calculation done only on active components; and
   c. calculate sparse code update from reconstruction error (with 100 MHz at least); calculation done only on active components.
3. working mode 2:
   a. update Q matrix with the actual sparse code, reconstruction error and learning rates of components; update is done only on active components;
   b. tune selected components towards a marked component with set learning rates for selected components; selection means that the actual sparse code is 1 at the selected components, whereas marking means that the actual sparse code is 2 at the marked component;
   c. randomize selected components; selection means that the actual sparse code is 1 at the selected components;
   d. remove small values from selected columns of Q; and
   e. normalize selected columns of Q to have unit length in some norm, e.g., L1 or L2.
4. working mode 3:
   a. calculate initial guess sparse code from reference input; calculation done only on active components;
   b. update W matrix with the sparse code error, reference input and learning rates of components; calculation done only on active components;
   c. tune selected components towards a marked component with set learning rates for selected components; selection means that the actual sparse code is 1 at the selected components, whereas marking means that the actual sparse code is 2 at the marked component;
   d. randomize selected components; selection means that the actual sparse code is 1 at the selected components; and
   e. remove small values from selected rows of W.

The following connections are provided:
1. sparse code and sparse code error is received from unit (H102);
2. sparse code update and initial sparse code guess is provided to unit (H102);
3. reconstructed input is provided to unit (H100);
4. reconstruction error is received from unit (H100);
5. Q and W matrices can be set and queried by the main I/O;
6. learning rates, and threshold for small value removal can be set and queried by unit (H103) and main I/O; and
7. working mode is set and queried by controller (H105).

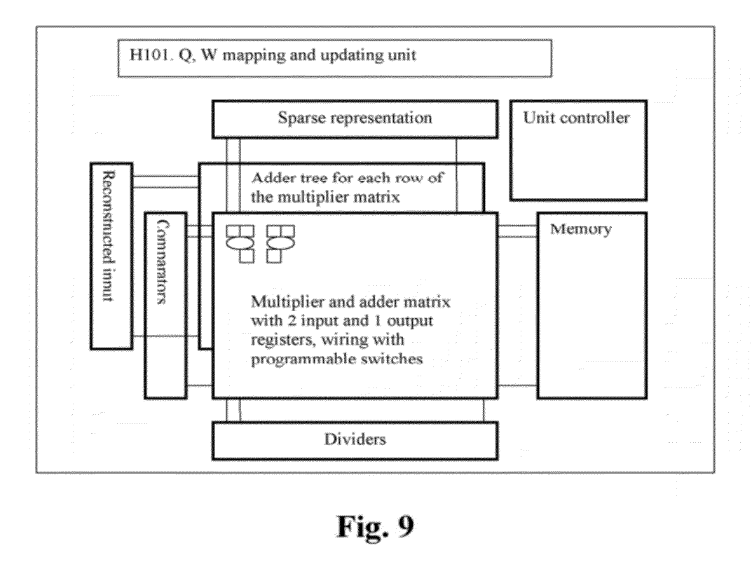

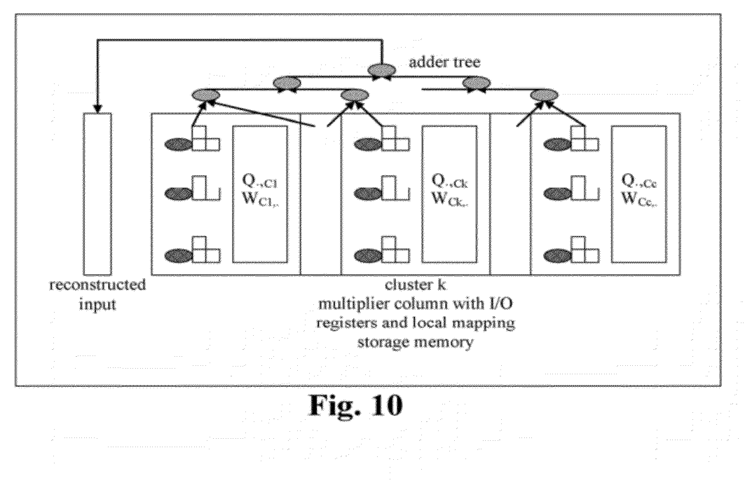

One implementation is the following. There is a separate part of a chip for operations on and storage of Q and W. The storage and operations are separated but are on the same chip. First the Q part is detailed. The Q matrix is stored in an on-chip RAM with memory controller which makes the matrix addressable by columns so that a whole column can be read from it or written into it. The operations area contains a full matrix multiplier with some additional components. The full matrix multiplier is composed of multipliers with 2 input registers and 1 output register for each and the multipliers are arranged in a matrix form (see FIG. 9). The number of columns determines the maximal number of active components the system can handle. It is preferable to have more columns than k, but no more than the number of clusters if the sparse representation is clustered. For each row of the multipliers there is a full adder tree (see FIGS. 9 and 10) that calculates the sum of that row in log n steps, and the result is written to an output register for each row.

More specifically, the input registers of the multipliers of FIG. 9 can be loaded with the columns of Q, with the actual sparse code (one column will have the same value of the corresponding component in the sparse code), with the reconstruction error (one row will have the same value of the corresponding component in the reconstruction error), and the value of the result register can be copied back. There is a matrix of adders, with each adder having 2 input registers and 1 output register placed next to a corresponding multiplier as conceptually illustrated in FIG. 8. The result register of the multiplier can be copied to the input registers of the adder, and the result register of the adder can be copied to the input registers of the multiplier. The result registers of one column of adders can be copied to the input registers of a column of comparators, and the other input registers of the comparator can be loaded with a threshold. The result registers of the comparator can be written to the input registers of one column of multipliers or adders. The input registers of one adder in each column of adders can be loaded with the result registers of all other multipliers or adders in that column. The result register of these adders in each column can be loaded to the input registers of a divider for each column. The result register of the divider can be loaded to the input registers of the multipliers or adders of the corresponding column.

There is a controller and a register for the working mode. The controller controls the units to execute the required operation and then sets the working mode to 0. The program of working mode 1,a,b is straightforward, there are multiple executions of this program with the same active components, but before the first iteration the columns of the active components are loaded to the first input registers of the multipliers (working mode 1a) and the working mode is set to 0. Whenever the working mode is set 1,b the actual sparse code is copied to the second input registers of the multipliers and the results of each row are summed by the adder tree and after the sum is ready the working mode is set to 0.

The program of working mode 2ade, described above, is the following. The matrix values should be in the first input registers of multipliers; if not they are loaded pursuant to working mode 1a. These matrix values are copied to the first input registers of the adders. The learning rate for each active component and the actual sparse code is loaded to the input registers of the multipliers and the result of the multiplication is copied back to the second input registers of the multipliers. The reconstruction error is loaded to first input registers of the multipliers and the result is loaded to the second input registers of the adders. The result of the adders is copied to the free input registers of the comparators, and the other input register of the comparators is loaded with the threshold when the threshold is set. The comparator result is loaded to both input registers of the multipliers to calculate L2 norms. The result of the multiplication is sequentially copied to the one adder to sum up each of the values in each column. The result is a denominator of the divider and the numerator is 1. The result of the division is loaded to the second input register of the multiplier and the result of the multiplication is written to RAM. After all columns are written, the working mode is set to 0.

The program of the working mode 2bde, described above, is the following. The selected components are loaded to the input registers of the multipliers, one minus learning rate of each component is loaded to the second input of the multipliers and the result is written to the first input of the adders. Then the marked component is loaded to all multipliers, learning rate is loaded to the second input of multipliers and the result is written to the second input of adders. The result of the adders is processed in the same way as in the 2ade program, when they are copied to the comparators. For program 2cde random number generators are required or the program can be run after some iterations of program 1b and the result of multipliers can be written back to the columns of selected components. The W matrix part and corresponding working modes have a similar structure.

In the case of clusters, the memory transfers may be made faster. There are k_{c} columns of multipliers for each cluster and the columns of Q are stored next to the multipliers in registers. A multiplier in a given row and cluster will only read and will only write the Q values corresponding to that row and cluster. FIG. 10 illustrates the case when k_{c} is 1. Note that only the multipliers and adder tree are in the figure, the other units required for tuning are omitted from this figure.

### 4. Processor Unit (H103)

The Processor unit (H103) of FIG. 7 runs the selection algorithm and adaptation, and controls the other components through the Controller (H105).

The following interface is provided:
1. setting and querying of the maintained measures of components, e.g. usage rate, learning rate;
2. algorithm parameter setting and querying; and
3. working mode setting and querying (0: idle, 1: process new input with adaptation, 2: process new input without adaptation).

The following operations are provided:
1. working mode 1:
   a. process new input with adaptation.
2. working mode 2:
   a. process new input without adaptation.

The following connections are provided:
1. The reconstruction error size is received from unit (H100);
2. The sparse code guess and calculated sparse code is received from unit (H102);
3. The learning rate's and active components are set in unit (H102);
4. The control information is sent to Controller (H105);
5. The control information is received from Controller (H105), preferably in the form of interruptions to avoid empty loops;
6. The unit (H104) is used for measure maintenance; and
7. The algorithm parameters and working mode are set and queried by main I/O.

One implementation is that there is a processor for each cluster with a random number generator and enough RAM to store the measures of components of the cluster. The two extreme implementations are when there is a separate processor for each component and the other is when there is only one processor. The first case might use too much power while the latter case might be too slow compared to the other units of the system shown in FIG. 7.

### 5. Inter-component Measures Estimator and RAM (H104)

This unit (H104) helps in the calculation and storage of measures among components, e.g., mutual information estimation, and pair-wise conditional probability of activation of components.

This unit (H104) contains multipliers and adders with separate input and output registers with programmable connections corresponding to at least the number of components within each cluster. Also, this unit (H104) has enough RAM to store measures precisely within a cluster and the large values of measures with components from other clusters.

### 6. Controller (H105)

This unit (H105) contains medium level programs to control other units, e.g. the sparse code calculation involves the cooperation of 3 units, and these are to be synchronized. This unit (H105) notifies the processors when the required operation is finished. The unit (H105) also has access to the working mode interface of other units and the interface of processors to signal the end of operations. It can be implemented by a small microcontroller.

### 7. I/O Interfaces (H110-H114)

FIG. 7 also illustrates the hardware input/output (I/O) interfaces. The primary input is the measurement values (H110). These values are scaled to be properly represented by the hardware. Additionally the matrices can be initialized through memory write operations (H111-114) accessing W by its rows and Q by its columns.

The primary outputs are the sparse signal (H113) and the reconstructed ĝ signal (H111) if available. Additionally the learned matrices can be retrieved from the hardware by memory read operations (H114, H112) and the reconstructed measurement can be obtained (H110).

In another embodiment, hybrid hardware may be used that is composed of a general purpose computer and the units (H100), (H101), (H101a) if the method in Section II is used, and (H102) of the above hardware. This hybrid solution offloads the computationally most expensive parts of the algorithms into the special hardware while the algorithmically complex part remains on the general purpose computer which can be programmed more freely than the above hardware. This allows the use of this hybrid solution in a wider range of algorithms. In this hybrid solution, the primary input includes calculation mode control information from the PC and sparse code setting.

C. Example Mapping from Pseudo Codes to Hardware

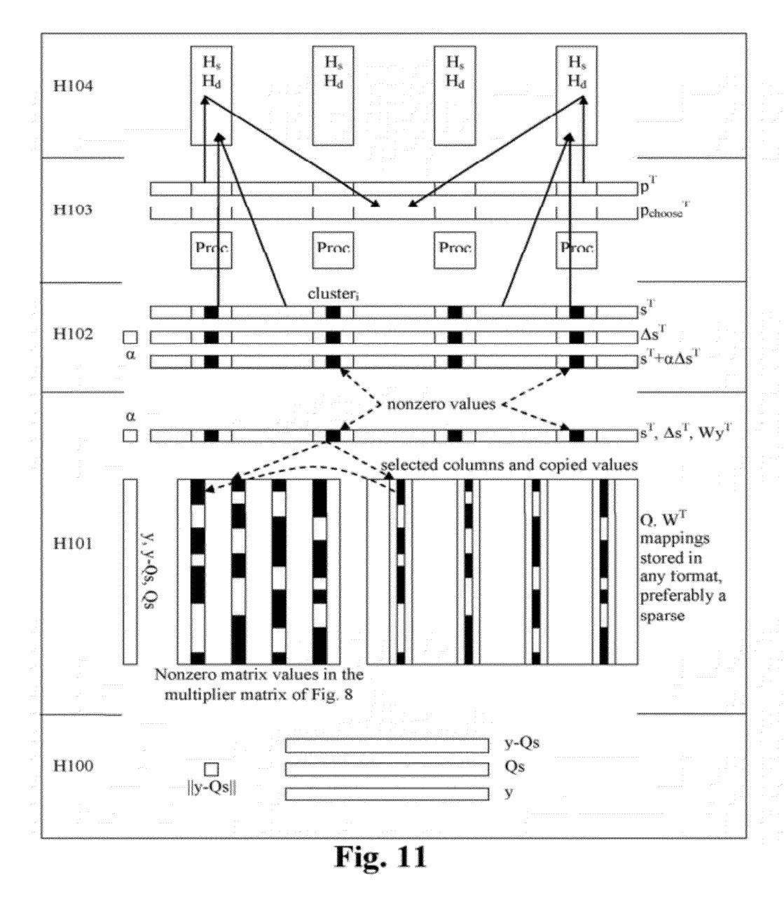

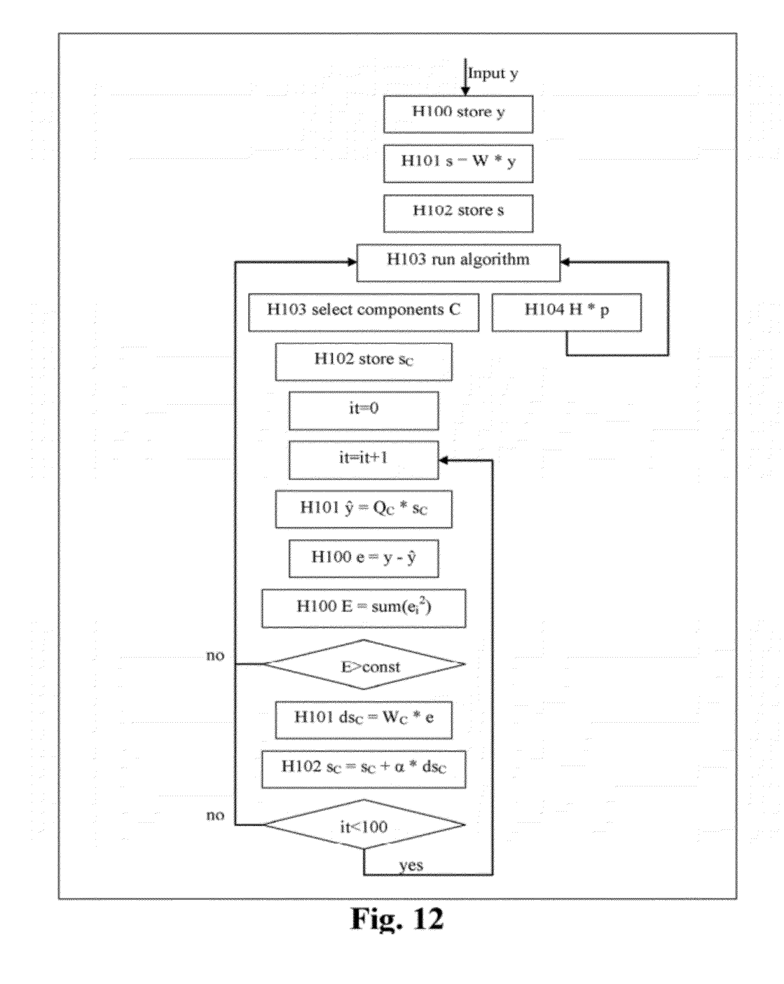

Most lines of the example pseudo codes would be executed in the procesor unit (H103). The other units are used during sparse code calculation and tuning of Q, W mappings, see FIG. 11 and FIG. 12.

During sparse code calculation the preferences of components are modified by similarity and dissimilarity measures. This modification is helped by (H104), e.g. multiplications and nonlinear transformations are executed in this unit and not in the processor unit. In FIG. 11, the H104 unit for each cluster calculates the modification of the preferences based on the preferences in the cluster. The update of similarity and dissimilarity measures are also aided by (H104) in a similar way. In FIG. 11, the H104 unit for each cluster calculates nonlinear transformations and multiplications of values of sparse representation components from other clusters and values of sparse representation components from the cluster of the unit.

During the calculation of the continuous values of the active components of a phenotype the following hardware units are used: (H100), (H101), (H101a) if the second method is used with signal measurement simulation (not shown in FIG. 11 and FIG. 12), (H102), and (H105) to control the working of the previous units. Once the processor unit (H103) selected the active components of a phenotype (H102 black marks in s) and the continuous values of the active components are initialized by the H101 unit, 1a3a program of (H101) (in FIG. 11 load matrix values of W and calculate initial values of active components: Wy), an iterative calculation begins that decreases the L2 norm of the reconstruction error y−Qs. This is the following program H101,1b; H100; H101,1a; H102,1; H101,1b; . . . . This iteration goes on until an iteration number limit is reached or the reconstruction error goes below a limit. In FIG. 11 during iteration the actual sparse representation is downloaded from the H102 s unit to the H101 s unit. Then the reconstructed input, Qs is calculated and copied from the H101 Qs unit to the H100 Qs unit. Note that the adder trees required for matrix multiplication are not shown in FIG. 11. In H100 the reconstruction error, y−Qs and its size ∥y−Qs∥ are calculated. Then the reconstruction error is copied from the H100 y−Qs unit to the H101 y−Qs unit and W(y−Qs) is calculated and written into the H101 Δs unit. This is copied to the H102 Δs unit and s+αΔs is calculated and copied back to the H102 s unit. From here starts the next iteration. Although the number of multipliers is maximally n*n usually much less multipliers are used because of the limited number of nonzero values in the sparse representation. If there are clusters then only k_{c} columns of multipliers are enough per cluster, which allows a modular combination of processing units and memory units as described above (see FIG. 10). Also, there are possibly many zero values in each column of Q, which reduces power consumption. The sparse mappings, clustered sparse representation, and the adaptive capabilities of the algorithms enable hardware failure tolerance by assigning zero values to places in the mappings that would be processed by failed hardware components (to not use those) and adapting the other values of mappings to these constraints.

During tuning of Q mapping the H101,2abcde program is executed on (H101). The sparse code calculation unit (H102) transfers the learning rates, and selected and marked components which are set by the processor unit (H103) before each subprogram starts. During this program the reconstruction error is copied from the H100 y−Qs unit to the H101 y−Qs unit and s is copied from the H102 s unit to the H101 s unit. Then (y−Qs)*(α.*s^{T}) is calculated for the nonzero components of s and added to the corresponding columns of Q. Then these columns are further modified in FIG. 11 (divider, adder and comparator units are not shown); see FIG. 9 for further details.

During tuning of W mapping the following program is executed: H101,3a;H102,2;H101,3bcde. This program calculates the calculated sparse code difference with the initial sparse code guess and executes all updates of the W matrix. During this program the input is copied from the H100 y unit to the H101 y unit, and Wy is calculated for the active components of the sparse representation and copied from H101 s to H102 Δs. Then s−Wy is calculated in H102 and copied from the H102 s+αΔs unit to the H101 As unit. Then (α.*Δs)*(y^{T}) is calculated for the nonzero components of s and added to the corresponding columns of W^{T}. Then these columns are further modified in FIG. 11 (divider, adder and comparator units are not shown), see FIG. 9 for further details.

In general the methods can be executed by the hardware in the following way, as shown in FIG. 12. An input signal is received and stored by H100, (S001, FIG. 2). Then sparse code calculation begins (S002, FIG. 2). First an initial value is calculated for each component. This is done by processor unit H103 setting active one component in each cluster and calculating the initial values of these by H101 3a program and then setting other components as active by processor unit H103 until all components have an initial guess (S202, FIG. 3). Then the processor unit H103 creates the initial preferences of all components (S202, FIG. 3). During phenotype generation H104 helps the processor unit H103 to modify the preferences of components by executing, e.g., multiplications, nonlinear transformations (S204, FIG. 3). For each phenotype the processor unit H103 selects some active components based on the modified preferences (S205, FIG. 3) (C, FIG. 12). Once the active components are selected their initial values are set in 5102 and continuous value calculation of these components is executed by H100-H102 as described above. The processor unit H103 retrieves the reconstruction error size from H100 and calculates the cost of each phenotype determines the elite set and updates the preferences. Once a sparse code is calculated it is truncated by processor unit H103 (S003, FIG. 2). The statistics and learning rates of the components are updated by processor unit H103 (S004-S007, FIG. 2). During the update of the similarity and dissimilarity measures H104 helps by executing, e.g. multiplications and nonlinear transformations. The transformation updates (S008-S010, FIG. 2) are executed by H100-H102 units controlled by the processor unit H103 and controller H105 as described above.

### V. Summary of the Hardware of the Present Invention

The computer architecture described in Section IV above for implementing the methods of the invention has the following main units. An input receiving and reconstruction error unit (H100) receives and stores the input and the reconstructed input, and it calculates the difference of the received input and the reconstructed input. A high-speed matrix-vector multiplication unit (H101) calculates and updates the transforms W and Q. A sparse code updating unit (H102) stores and updates the first sparse code. A processor unit (H103) containing at least one processor executes those parts of the methods that are not executed by other units. The input receiving and reconstruction error unit, the high speed matrix multiplication unit, and the sparse code updating unit forms a closed loop to calculate the continuous values of the active components of the first sparse code. This architecture can be extended with a unit (H104) calculating the modified preferences from the preferences of the components of the sparse code and updating similarity and dissimilarity measures of components.

The computer architecture also benefits from a clustered sparse code where within each cluster of components only a limited number of components can be active at a time. In this case the high speed matrix-vector multiplier unit (H102) can be divided into parts corresponding to clusters. Each part is responsible for calculating and storing the parts of transforms W and Q corresponding to the components of the cluster the part is responsible for. In this case a processing part of the processor unit (H103) can be assigned to a cluster, with each cluster having a separate processing part.

### VI. Applications Generally

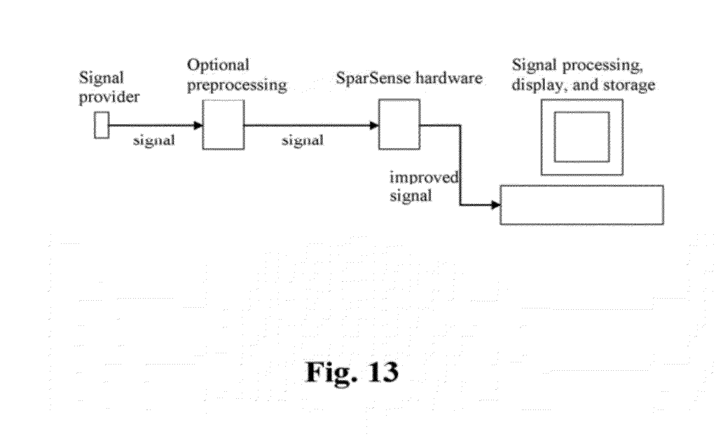

FIGS. 13-15 are used to describe, broadly, application areas of the present invention.

Additional signal pre-processing before the signal is processed by these algorithms can be applied. Signal pre-processing favouring sparse representation, e.g., independent component analysis, can improve the performance of these algorithms.

In general for the processing of time series of signals (e.g. video) there are more ways. The simplest way is to ignore the possible dependencies of signals coming after each other (e.g. process the frames of a video one-by-one). Also, there are more ways which can be combined to take into account the time dependency of the signal. One way is to use concatenated signal as input for the processing. The signals within a time window are concatenated to form a single input (e.g. multiple frames forms a single input). Then the Q and W mappings will map time series of the signal thus the components of the sparse representation will represent time series of the signal. Another way to use time dependency of input signals is to use convolved input next to the one time input. This does not increase the input dimension of the algorithm as the time depth is increased. A dynamical model can be learned on the sparse representation and the sparse representation of the next signal can be predicted from the already calculated sparse representations. Here small dimensional embedding helps the learning of the dynamical model as in the case of similarity and dissimilarity measures. The dynamical model can be hardwired, also.

### A. Signal Preprocessing (FIG. 13)

For general purpose signal preprocessing the algorithms can be used to filter out noise from a signal, and for pattern completion to decrease the required measurement time for a given signal quality, or to improve signal quality, e.g. resolution, sharpness, signal-to-noise ratio. The columns of matrix Q form the basic patterns from which the signal is reconstructed. Some values might be missing from the signal or corrupted (e.g. missing or noisy pixels in an image). The patterns in matrices Q and W that are selected are based on the available values in the signal that can reconstruct the missing or corrupted values.

In this general case with reference to FIG. 13, the algorithm receives the signal from a signal provider device (e.g. CCD camera, spectrometer, MRI coils), removes noise from signal and restores the required quality signal. The preprocessed, improved signal is transmitted to the signal processor, display, storage, etc device that corresponds to the actual use of the signal and application. This includes, e.g., the case when the signal is an image provided by a video-card to be displayed on a monitor and the algorithm improves the image between the video card and the monitor.

Signal super-resolution can be achieved with both the first and the second method of the invention, that is the reconstructed signal will be higher dimensional (e.g. more pixels in an image) than the original signal. With the second method this can be achieved by using an interpolated G matrix that maps to larger signals (e.g. images) than the original G matrix. With the first method this can be achieved by interpolating the columns of Q matrix.

Specific applications (described more fully below in Section VII): A: MRI; B: Thermal Scanner; C: Spectrometer; D: Internet TV; F: Telesurgery; G: Product Testing.

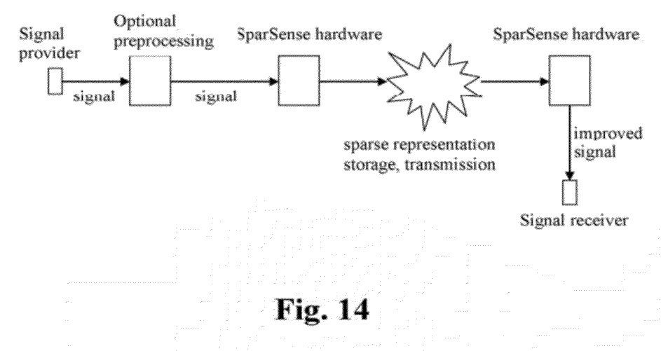

### B. Signal Compression (FIG. 14)

With reference to FIG. 14, for signal compression and decompression it is required to store matrices Q and W with which the signal was compressed in order to retrieve the signal. The compression is almost lossless; the unstructured noise is filtered out from the signal during compression. The compressed signal is the sparse representation of the signal, which is to be stored or transmitted. The sparse representation achieves compression by coding only the nonzero components' indices and values plus error correction if required. The amount of compression is application dependent. In some cases compression to 1% can be achieved.

In a typical scenario the received signal is compressed somewhere and at another time and possibly at another place it is restored by the algorithms using the same matrices as used for the compression.

Specific applications (described more fully below in Section VII): A: MRI; B: Thermal Scanner; C: Spectrometer; D: Internet TV; E: Multiplayer Online Games; F: Telesurgery.

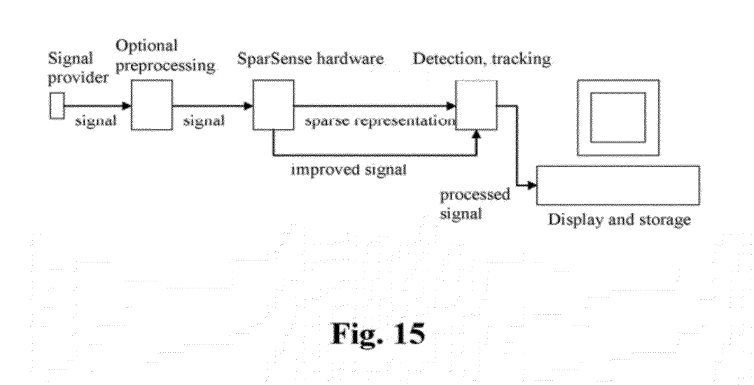

### C. Signal Component Regression, Detection, and Tracking (FIG. 15)

With reference to FIG. 15, the calculated sparse representation can be used to improve component detection and tracking in the signal (e.g. object recognition, face recognition, face tracking). Also, the sparse representation can be used to improve regressions of signal components. The otherwise used detector and tracker methods can be used on the sparse representation. Also, other methods can be used.

### VII. Inventive Methods and Designs

The current patent application expands the methods and apparatus described in U.S. patent application Ser. No. 12/062,757, filed Apr. 4, 2008, entitled “PARALLEL AND ADAPTIVE SIGNAL PROCESSING” by Zsolt Palotai et al., which application claims benefit of U.S. Provisional Application No. 61/023,026 entitled “PARALLEL AND ADAPTIVE SIGNAL PROCESSING” by Zsolt Palotai et al., filed Jan. 23, 2008, to which priority to both applications has been claimed.

### A. Scalable Hierarchical Sparse Representations

Hierarchical sparse representations make possible to process arbitrarily large signals with constant sized sparse representation calculation and learning algorithms.

At each level of the hierarchy the input signal of the level is divided into possibly overlapping blocks. Each block is then processed by an algorithm that divides the data of the block into a low dimensional part and an error part. Such algorithms are, e.g., SVD, Robust PCA (RPCA, E. J. Candès, X. Li, Y. Ma, and J. Wright. Robust Principal Component Analysis? Submitted for publication. http://www-stat.stanford.edu/˜candes/papers/RobustPCA.pdf, which is incorporated by reference herein in its entirety.) The error part of each block is then processed by the previously described parallel and adaptive signal processing algorithms. The aggregate of the low dimensional parts forms the input signal of the next level in the hierarchy.

The higher the level the larger the structures that will be represented by the sparse representations of the blocks of that level. To reconstruct the original signal a new transformation is to be learnt for each level. These transformations directly map to the original signal from the sparse representations of the error parts at each level. For reconstruction the top-down transformations are masked so that the sum of transformations of overlapping blocks will reconstruct the input signal. Such masks can be e.g. sin̂2 based mask, or division by 2 if each input data is covered by 2 blocks.

In an extension of the method edge preserving nonlinear diffusion is applied on the input signal of each level, before the blocks are created from the signal. This reduces the noise in the signal to be processed. The original signal reconstructing transformations are learnt on signals which are not diffused.

### B. Feedforward Bottom-Up Estimation

Clustered representation can be calculated in a feedforward way if every component within the selected clusters is active.

The continuous values of the components are not optimized for reconstruction but the bottom-up value is used during reconstruction with the selected clusters.

The active clusters are selected either by the selection based method described above (without the continuous value optimization) or by a greedy algorithm. Iteratively that cluster will be activated next which reduces the cost the most, the iteration stops when there are no clusters reducing the current cost, or after reaching a preset limit of iteration number. The cost function is the sum of the reconstruction error and the weighted L1 norm of the activated clusters.

Topography can be introduced among the clusters. If a cluster is activated then the neighboring clusters cannot be activated later. In this case the weight of a cluster in the cost function depends on its neighbor clusters. If the bottom-up values of components of neighbor clusters are large then the weight is small.

The active clusters can be used to regularize a sparse representation. Each component of the sparse representation is assigned to a cluster. Only that component can be active in the sparse representation which belongs to an active cluster. Alternatively all components of the sparse representation belonging to an active cluster are selected to be active, and their continuous values are optimized to reconstruct their error part. Further components are selected to reconstruct the remaining error.

Alternatively the clusters can determine the initial preferences of the components of the sparse representation by Bayesian methods, e.g. semi Naïve Bayes method (Calonder M., Lepetit V., Fua P.: Keypoint Signatures for Fast Learning and Recognition. 10th European Conference on Computer Vision (ECCV), Marseille, France. LNCS Springer, October 2008, which is incorporated by reference herein in its entirety.)

In the hierarchy, described previously, the clustered representation is calculated on the low dimensional part. The sparse representation calculation on the error part is constrained by the clustered representation calculated on the low dimensional part.

### C. Top-Down Influence

The sparse representations of different levels can further decrease the complexity of sparse representation calculation. Each component of the sparse representation at a lower level is assigned to a component in the sparse representation of the upper level. A component of the sparse representations at the lower level can be active only if it is assigned to an active component of the sparse representation at the upper level. Alternatively the lower level components assigned to active components at the higher level are selected to be active, and their continuous values are optimized to reconstruct their error part. Further components are selected to reconstruct the remaining error.

In a further alternative the active higher level sparse representation components can determine the initial preferences of lower level sparse representation components by some Bayesian method, e.g. semi Naïve Bayes.

### D. Prediction

The low dimensional part is suitable for prediction, simple AR models work efficiently on low dimensional continuous representations. The upper level predictions can constrain the lower level predictions. This can be done by overwriting the prediction at the lower level based on the higher level prediction and/or by directly constraining the predictive model of the lower level by the higher level model.

What is claimed is:

1. Apparatus and methods of scalable hierarchical signal processing comprising
(a) at least one level of the hierarchy;
(b) an algorithm to create possible overlapping blocks from the input signal of the level;
(c) an algorithm decomposing each block of the input signal of the level into a low dimensional part and an error part;
(d) signal processing algorithm working on each of the error parts, described in the U.S. patent application Ser. No. 12/062,757, titled “Parallel and adaptive signal processing,” filed on Apr. 4, 2008 to which a claim for priority has been made herein;
(e) the input signal of the next level of the hierarchy is the aggregate of the low dimensional parts of the blocks of the level; and
(f) the original input signal of the hierarchy is reconstructed by the sum of highest low dimensional parts and the reconstructions of the sparse representations at each level.

2. The method of claim 1 where the algorithm decomposing each block of the input signal is the Robust Principal Component Analysis as described e.g. in E. J. Candès, X. Li, Y. Ma, and J. Wright. Robust Principal Component Analysis? Submitted for publication. http://www-stat.stanford.edu/˜candes/papers/RobustPCA.pdf.

3. The method of claim 1 where the algorithm to create blocks from the input signal creates a first rectangular tiling of the input signal (e.g. image), and second rectangular tiling which is shifted relative to the first tiling by half of the rectangles in each direction.

4. The method of claim 1 in which nonlinear diffusion is applied on the input signals of each level before the blocks are created.

5. Apparatus and methods of clustered representation comprising
(a) at least 2 clusters of components;
(b) where each component is active in the selected cluster(s);
(c) the components have feedforward bottom-up continuous values; and
(d) the components are selected to optimize the cost function of the sum of the reconstruction error and the weighted L1 norm of the selected clusters.

6. The method of claim 5 where the components are selected based on the Selection based Method without the continuous value optimization step described in the U.S. patent application Ser. No. 12/062,757, titled “Parallel and adaptive signal processing,” filed on Apr. 4, 2008 to which a claim for priority has been made herein.

7. The method of claim 5 where the components are selected by a greedy algorithm, the algorithm selects that cluster to be activated in the next step which reduces the cost function the most, and the algorithm stops when there are no clusters improving the cost function.

8. The method of claim 5 where the clusters are organized into topography such that if a cluster is selected to be active then the neighbors of the cluster cannot be selected later to be active, and the weight of a cluster in the L1 norm part of the cost function is small if the components of the neighbor clusters have a large magnitude.

9. The method of claim 1 and claim 5 where the clustered representation is calculated on the low dimensional parts of the blocks at each level, and each component of the sparse representation is assigned to a cluster of the clustered representation.

10. The method of claim 9 where a component of the sparse representation can be active only if the corresponding cluster is selected to be active.

11. The method of claim 9 where each component of the sparse representation assigned to an active cluster is activated and continuous values of the active sparse representation components are optimized to reconstruct the error part of the blocks, and sparse representation components can be selected to improve the reconstruction.

12. The method of claim 9 where the clusters determine the initial preferences of the sparse representation components by Bayesian methods, including semi Naïve Bayes method (Calonder M., Lepetit V., Fua P.: Keypoint Signatures for Fast Learning and Recognition. 10th European Conference on Computer Vision (ECCV), Marseille, France. LNCS Springer, October 2008).

13. The method of claim 1 where a higher level sparse representation influences the lower level sparse representations, and a component of the lower level sparse representation is assigned to a higher level sparse representation component.

14. The method of claim 13 where a lower level component can be activated only if it is assigned to an active higher level sparse representation component.

15. The method of claim 13 where all of the lower level sparse representation components are selected to be active which are assigned to active higher level sparse representation components, the continuous values of the lower level activated components are optimized to reconstruct the error part of the lower level, and components can be selected to improve the reconstruction.

16. The method of claim 1 where the active higher level sparse representation components determine the initial preferences of the lower level sparse representation components by a Bayesian method, such as the semi Naïve Bayes method (Calonder M., Lepetit V., Fua P.: Keypoint Signatures for Fast Learning and Recognition. 10th European Conference on Computer Vision (ECCV), Marseille, France. LNCS Springer, October 2008).

17. The method of claim 1 where predictive models are working on the low dimensional parts.

18. The method of claim 17 where a higher level predictive model is constraining some lower level predictive models.

19. The method of claim 18 where the constraining is done by partially overwriting the result of the lower level model.

20. The method of claim 18 where the constraining is done during model learning.
